(19) United States
(12) Patent Application Publication
(10) Pub. No.: US 2017/0184844 A1
(43) Pub. Date: Jun. 29, 2017

(54) DISPLAY LIGHT PROJECTING OPTICAL SYSTEM

(71) Applicant: YAZAKI CORPORATION, Tokyo (JP)

(72) Inventor: Junichi Matsushita, Shizuoka (JP)

(21) Appl. No.: 15/385,297

(22) Filed: Dec. 20, 2016

(30) Foreign Application Priority Data
Dec. 24, 2015 (JP) 2015-251912

(51) Int. Cl. G02B 27/01; G02B 5/30; G02B 27/00; G02B 27/14; G02B 5/09

(52) U.S. Cl. CPC G02B 27/0101; G02B 27/142; G02B 5/09; G02B 27/0018; G02B 5/3083; G02B 1/11

(57) ABSTRACT

P-polarized display light is projected onto a Fresnel mirror sealed body from an HUD unit, whereby reflection at the front surface and the back surface of the Fresnel mirror sealed body is suppressed. The angle of incidence of display light on the Fresnel mirror sealed body is set close to a Brewster's angle to suppress the reflection further. The p-polarized display light is generated by producing linearly polarized display light by a liquid crystal display that incorporates a polarizing plate and then adjusting its polarization direction by a half-wave plate or by inputting unpolarized display light to a polarizing plate. The use of p-polarized light makes it possible to suppress unnecessary reflection. The reflection can be minimized by setting the incident angle at the Brewster's angle.

### CROSS REFERENCE TO RELATED APPLICATIONS

This application is based on and claims priority from Japanese patent application No. 2015-251912 filed on Dec. 24, 2015, the entire contents of which are incorporated herein by reference.

### BACKGROUND OF THE INVENTION

1. Technical Field

The present invention relates to a display light projecting optical system which is equipped with a display unit for emitting display light and a Fresnel mirror which reflects the display light coming from the display unit with image enlargement and transmits external light.

2. Background Art

In general vehicular head-up display (HUD) devices, an optical path is formed so that an optical image including various kinds of information to be displayed is projected onto a windshield (front window glass plate) or a reflection plate called a combiner and light reflected from it goes toward the eye point of a driver. As a result, the driver can visually recognize, as a virtual image, the HUD visible display information displayed on the windshield or combiner while viewing a scene ahead of the vehicle through the windshield. That is, the driver can visually recognize various kinds of information through display of the HUD without the need for moving his or her line of sight while driving the vehicle ordinarily.

Patent document JP-A-2012-123393 discloses a display device in which a special optical element (corresponding to the above-mentioned combiner) is bonded to the glass surface of a windshield. Light emitted from an HUD unit is reflected by the surface of the optical element formed on the windshield and goes toward the eye point of a driver. Since the optical element is made of a material that transmits visible light, the driver can see not only a display image that is formed ahead of the optical element as a virtual image but also a scene etc. ahead of the vehicle through the windshield and the optical element.

In the display device of Patent document JP-A-2012-123393, a magnifying optical system is formed by forming a Fresnel lens on the optical element, whereby the HUD unit can be miniaturized. Furthermore, the use of the Fresnel lens makes it possible to reduce the thickness of the optical element.

### SUMMARY

In display devices like the one disclosed in Patent document JP-A-2012-123393, a Fresnel mirror is integrated with or bonded to the windshield of a vehicle or a combiner. Most of light emitted from an HUD unit is reflected by the surface of the Fresnel mirror with image enlargement and then recognized as a display image by a driver at his or her eye point. However, in actuality, light is reflected by the surface of a sealing member existing upstream of the Fresnel mirror, the surface of a base member existing downstream of the Fresnel mirror, and other surfaces, and images of resulting reflection light beams are formed in the vicinity of the intended display image.

Furthermore, whereas light reflected from the surface of the Fresnel mirror forms an enlarged display image, light reflected from the other surfaces form equal-magnification images. Thus, there are clear differences between the intended display image and the other images. For example, in forming a display image as shown in FIG. 5(a) of Patent document JP-A-2012-123393, an equal-magnification double ghost image appears in the vicinity of the regular display image as shown in FIG. 5(b) of Patent document JP-A-2012-123393. This may lower the legibility of the regular display image and the display quality.

The present invention has been made in view of the above circumstances, and an object of the invention is therefore to provide a display light projecting optical system capable of preventing or suppressing generation of an equal-magnification double ghost image in the vicinity of a regular display image that is formed through reflection by the surface of a Fresnel mirror.

To attain the above object, the display light projecting optical system according to the invention has the following features (1) to (5):

(1) A display light projecting optical system comprising:
a display unit which emits display light; and
a Fresnel mirror which reflects the display light coming from the display unit with image enlargement and transmits external light, the Fresnel mirror comprising:
   a first member having a Fresnel-shaped surface formed with Fresnel-shaped plural grooves and a first surface on which the external light is incident;
   a half mirror layer which is formed on the Fresnel-shaped surface; and
   a second member which has a second surface on which the display light coming from the display unit is incident, and which seals the half mirror layer between itself and the first member,
wherein p-polarized display light is incident on the second surface.

(2) The display light projecting optical system according to the above item (1), wherein the display unit emits the p-polarized display light so that it is incident on the second surface at an incident angle that is close to a Brewster's angle.

(3) The display light projecting optical system according to above item (1) or (2), wherein the display unit comprises:
a light source which emits display light; and
a polarizing member which polarizes the display light emitted from the light source into p-polarized light for the second surface.

(4) The display light projecting optical system according to the above item (3), wherein:
the light source emits linearly polarized display light; and
the polarizing member is a half-wave plate which polarizes the linearly polarized display light into p-polarized light for the second surface.

(5) The display light projecting optical system according to the above item (3), wherein:
the light source emits unpolarized display light; and
the polarizing member is a polarizing plate which polarizes the unpolarized display light into p-polarized light for the second surface.

According to the display light projecting optical system having the configuration of item (1), since a display image is formed by projecting p-polarized display light, reflection of incident display light by a surface other than the surface of the half mirror layer is suppressed, whereby occurrence of an equal-magnification double ghost image can be suppressed. When light is reflected by the boundary surface between different substances, s-polarized light and p-polarized light are defined according to the relationship between the oscillation direction of its electric field component or magnetic field component and the plane of incidence. Since as described later there exists a tendency that the reflectance of p-polarized light is smaller than that of s-polarized light, occurrence of an equal-magnification double ghost image can be suppressed by using only p-polarized light.

According to the display light projecting optical system having the configuration of item (2), occurrence of an equal-magnification double ghost image can be suppressed more effectively. More specifically, by making p-polarized display light be incident on the second surface at an incident angle that is close to the Brewster's angle, the reflectance at the second surface is made approximately equal to 0, whereby generation of unnecessary reflection light can be prevented.

According to the display light projecting optical system having the configuration of item (3), even in the case of using a light source that emits display light that is not p-polarized light, the polarizing member serves to prevent an s-polarized component from being incident on the second surface, whereby generation of unnecessary reflection light can be suppressed.

According to the display light projecting optical system having the configuration of item (4), since the half-wave plate serves to generate p-polarized light from linearly polarized display light emitted from the light source, s-polarized component is prevented from being incident on the second surface, whereby generation of unnecessary reflection light can be suppressed.

According to the display light projecting optical system having the configuration of item (5), since the polarizing plate serves to generate p-polarized light from unpolarized display light emitted from the light source, s-polarized component is prevented from being incident on the second surface, whereby generation of unnecessary reflection light can be suppressed.

The display light projecting optical system according to the invention makes it possible to prevent or suppress occurrence of an equal-magnification double ghost image that accompanies a regular display image that is formed through reflection by the surface of the Fresnel mirror. That is, since a display image is formed by projecting p-polarized display light, reflection of incident display light by a surface other than the surface of the half mirror layer is suppressed, whereby occurrence of an equal-magnification double ghost image can be suppressed.

The invention has been described above concisely. The details of the invention will become more apparent when the modes for carrying out the invention (hereinafter referred to as an embodiment) described below are read through with reference to the accompanying drawings.

### BRIEF DESCRIPTION OF THE DRAWINGS

FIG. 1 is a perspective view showing an example configuration of a dashboard, a windshield, and their neighborhood of a vehicle in which a display light projecting optical system according to the embodiment of the present invention is installed;

FIG. 2 is a vertical sectional view, as view from the side, of the same things as shown in FIG. 1;

FIG. 3 shows an example structure of a Fresnel mirror sealed body included in the display light projecting optical system and related example optical paths;

FIGS. 4A, 4B, and 4C are a plan view, a sectional view taken along line A-A in FIG. 4A, and a sectional view taken along line B-B in FIG. 4A, respectively, showing an example structure of a Fresnel lens that is included in the Fresnel mirror sealed body;

FIG. 5 shows an example image that may be seen at an eye point unless a proper countermeasure is taken; and

FIG. 6A shows an example optical path of light that passes through the Fresnel mirror sealed body, FIG. 6B is a reflection characteristic at the front surface of the Fresnel mirror sealed body, and FIG. 6C is a graph showing a reflection characteristic at the back surface of the Fresnel mirror sealed body.

### DETAILED DESCRIPTION OF EMBODIMENTS

A specific embodiment of the present invention will be hereinafter described with reference to the drawings.

### <Specific Example of Usage Environment of Display Light Projecting Optical System>

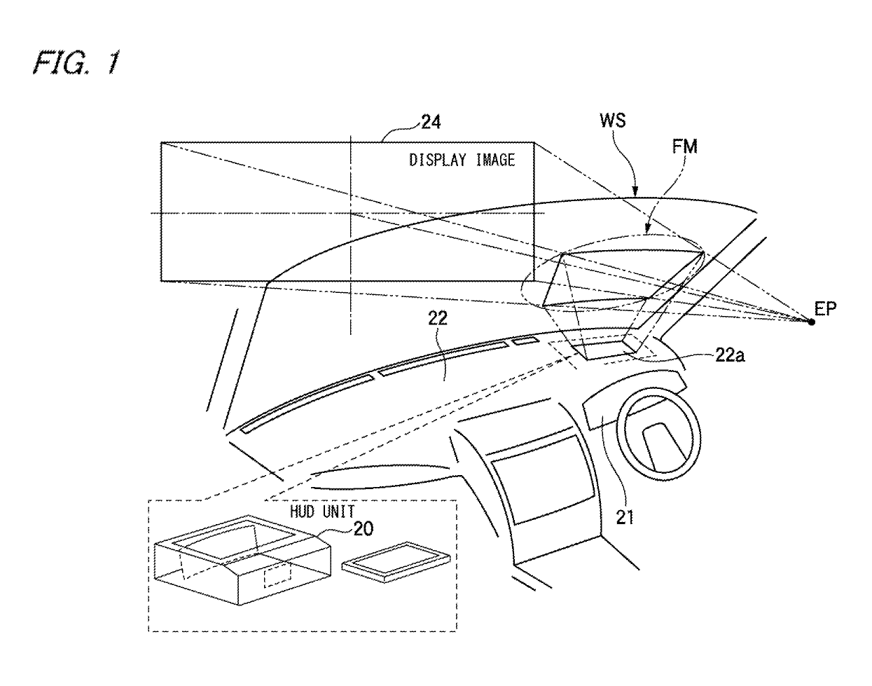

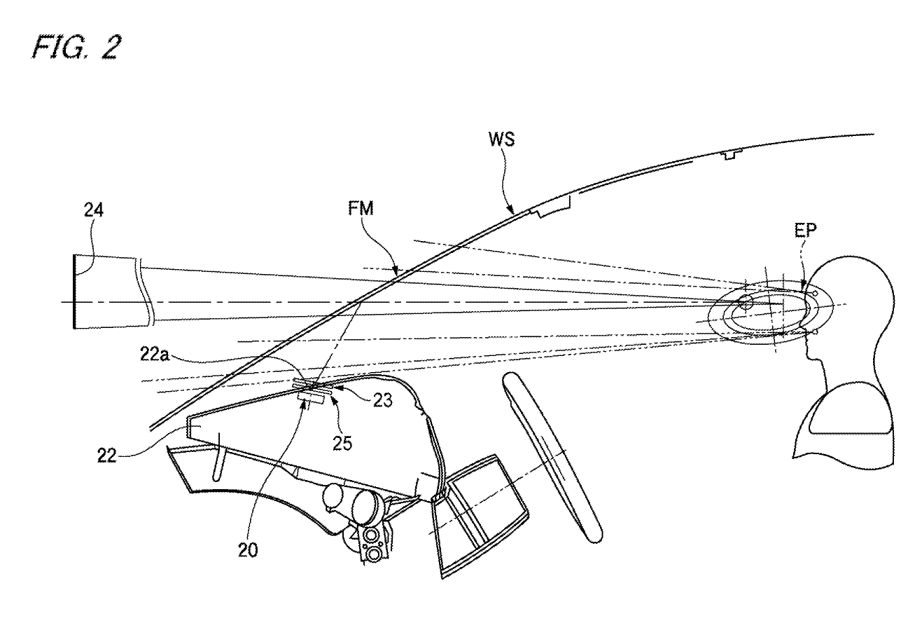

FIG. 1 shows an example configuration of a dashboard, a windshield WS, and their neighborhood of a vehicle in which a display light projecting optical system according to the embodiment is installed. FIG. 2 is a vertical sectional view, as view from the side, of the same things as shown in FIG. 1.

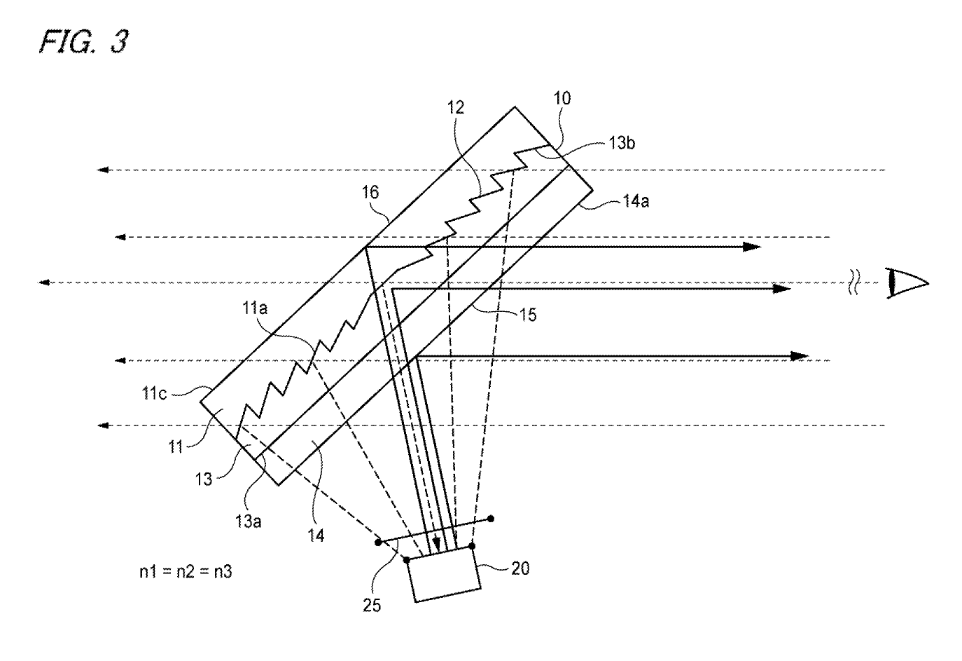

In the example shown in FIGS. 1 and 2, a Fresnel mirror sealed body 10 (See FIG. 3) is incorporated as an intermediate layer in a windshield WS (window glass plate) which is a laminated glass plate. A Fresnel mirror region FM is formed in the Fresnel mirror sealed body 10. Basically having a half mirror function, the Fresnel mirror sealed body 10 has such a characteristic as to reflect light that is incident on the Fresnel mirror region FM from inside the vehicle compartment, and to transmit light that travels rightward in FIG. 2 from outside of the vehicle and is incident on the Fresnel mirror region FM. The Fresnel mirror region FM forms a magnifying optical system by means of a Fresnel lens. A specific structure of the Fresnel mirror sealed body 10 will be described later in detail.

Although the example shown in FIGS. 1 and 2 is directed to the case that the Fresnel mirror sealed body 10 is incorporated in the windshield WS of the vehicle, the Fresnel mirror sealed body 10 may be disposed in the vicinity of the windshield WS as a combiner for a head-up display (HUD) device that is independent of the windshield WS.

In the vehicle shown in FIG. 1, an HUD unit 20 is disposed under a dashboard 22 which is located in front of a meter unit 21. The HUD unit 20 incorporates a flat panel display that includes a transmission liquid crystal panel and a polarizing plate and an illumination light source (backlight). Various kinds of information helpful in driving the vehicle such as a vehicle speed are displayed on the screen of the flat panel display when necessary in the form of visible information such as characters, numerals, symbols, etc. By illuminating the screen by means of the backlight, display light carrying the displayed visible information can be emitted from the HUD unit 20.

Since the flat panel display incorporates the polarizing plate, display light that is emitted from the HUD unit 20 is linearly polarized light. To obtain p-polarized light from the linearly polarized light, a half-wave plate 25 (described later) is disposed between the HUD unit 20 and the Fresnel mirror sealed body 10.

A rectangular opening 22a is formed in the dashboard 22 over the HUD unit 20. Display light that is emitted from the HUD unit 20 goes toward the windshield WS past the opening 22a. The windshield WS has the above-mentioned Fresnel mirror region FM in such a range as to receive display light coming from the HUD unit 20.

Thus, display light emitted from the HUD unit 20 is incident on the surface of the windshield WS, is reflected by the Fresnel mirror region FM, and reaches the eye point EP which corresponds to the eyes of a driver assumed. Since the display light is reflected by the Fresnel mirror region FM, a display image to be seen by the driver is formed as a virtual image as if to be displayed in a virtual image forming plane 24 that is located ahead of the windshield WS (e.g., 10 m ahead). Since the Fresnel mirror region FM transmits light coming from ahead of the vehicle in the same way as the windshield WS, the driver can see a scene ahead of the vehicle through the Fresnel mirror region FM. That is, the driver can see the scene ahead of the vehicle and the display image of the HUD unit 20 simultaneously in a superimposed manner.

By virtue of the employment of the Fresnel mirror, the Fresnel mirror region FM is so thin that it can be incorporated in the windshield WS. Since the Fresnel mirror region FM forms a magnifying optical system, it is not necessary for the HUD unit 20 to incorporate a magnifying optical system. The opening area of the opening 22a can be made smaller than in a case that the HUD unit 20 incorporates a magnifying optical system.

A louver 23 is disposed in the vicinity of the opening 22a. The louver 23 has a function of suppressing an event that unnecessary external light reflected in the vicinity of the opening 22a goes toward the eye point EP, whereby the legibility of a display image of the HUD unit 20 is increased.

### <Fresnel Mirror Sealed Body 10>

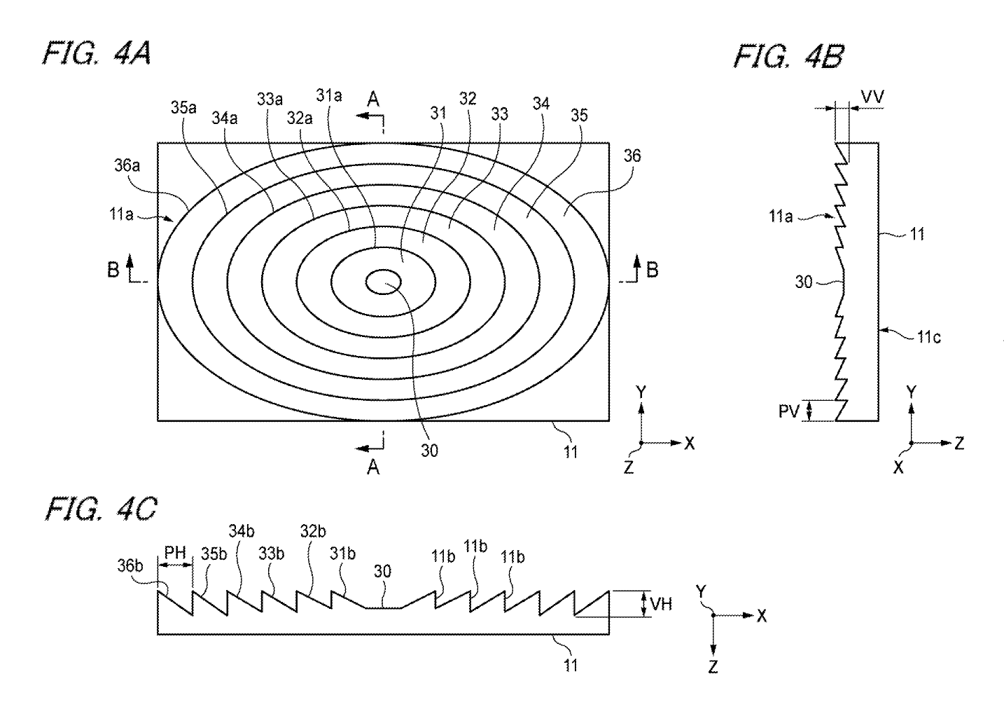

FIG. 3 shows an example structure of the Fresnel mirror sealed body 10 included in the display light projecting optical system and related example optical paths. The Fresnel mirror sealed body 10 shown in FIG. 3 is formed as a combiner for projecting display light of the HUD unit 20. The Fresnel mirror sealed body 10 has the same rectangular shape as a Fresnel lens 11 (see FIG. 4A) does, and is larger in size than the Fresnel mirror region FM shown in FIG. 1.

As shown in FIG. 3, the Fresnel mirror sealed body 10 is composed of plural layers that are laid one on another in its thickness direction. More specifically, the Fresnel mirror sealed body 10 is equipped with, in addition to the Fresnel lens 11 which serves as a substrate, a half mirror layer 12, a sealing agent layer 13, a transparent plate 14, and AR coating layers 15 and 16.

The half mirror layer 12 is formed on the surface of a Fresnel-shaped portion 11a of the Fresnel lens 11. More specifically, the half mirror layer 12 is formed by vapor-depositing a metal or dielectric multilayer film on the surface of the Fresnel-shaped portion 11a. In the embodiment, the half mirror layer 12 is formed so that reflectance of 20% is obtained there. The thickness of the half mirror layer 12 is set at 100 nm or less.

In the embodiment, in forming the half mirror layer 12, Fresnel erection surfaces 11b of the Fresnel-shaped portion 11a are not subjected to vapor deposition. That is, the half mirror layer 12 is formed on all of the surfaces excluding the Fresnel erection surfaces 11b which are located at the boundaries between the plural grooves of the Fresnel-shaped portion 11a and are parallel with the thickness direction of the Fresnel lens 11. In this case, since no portions of the half mirror layer 12 are formed on the Fresnel erection surfaces 11b, reflection at the Fresnel erection surfaces 11b that takes optical paths other than ordinary transmission or single-reflection paths are suppressed, whereby generation of unintended light rays by such reflection is minimized. Thus, the degree of generation of flare images is lowered.

The sealing agent layer 13 is provided to form a flat surface by covering the projections and recesses of the Fresnel-shaped portion 11a. The sealing agent layer 13 is formed by charging and setting a transparent material such as an ultraviolet (UV)-curing resin. The material of the sealing agent layer 13 is restricted to ones whose refractive indices n3 are approximately the same as the refractive index n1 of the Fresnel lens 11.

A surface 13a, located on one side (on the side of the transparent plate 14), of the sealing agent layer 13 is flat, and the other surface 13b that is in close contact with the Fresnel-shaped portion 11a or the half mirror layer 12 has such a shape as to compensate for the projections and recesses of the Fresnel-shaped portion 11a.

The transparent plate 14 is provided to protect the surface of the Fresnel mirror sealed body 10. The transparent plate 14 is formed as a thin plate using a transparent material whose refractive index n2 is approximately the same as the refractive index n1 of the Fresnel lens 11.

As shown in FIG. 3, the AR (anti-reflection) coating layers 15 and 16 are formed as two respective outside surfaces, in the thickness direction, of the Fresnel mirror sealed body 10. The AR coating layers 15 and 16 suppress reflection of light that is incident on the Fresnel mirror sealed body 10 from outside the vehicle and light emitted from the HUD unit 20. Thus, the AR coating layers 15 and 16 provide a specific advantage that generation of an equal-magnification ghost image and halation due to internal diffuse reflection can be prevented.

The AR coating layers 15 and 16 can be formed by anti-reflection treatment forming, for example, a dielectric multilayer film (anti-reflection treatment). Another method for providing the anti-reflection function is to form minute projections and recesses such as a moth-eye structure by nano-imprinting.

In the example shown in FIGS. 1 and 2, the Fresnel mirror sealed body 10 shown in FIG. 3 is incorporated, as an intermediate layer, in and thereby integrated with the windshield WS. That is, the half mirror layer 12 of the Fresnel mirror sealed body 10 forms the Fresnel mirror region FM shown in FIGS. 1 and 2. Being equivalent in optical characteristics to a Fresnel lens having optical magnification because of the shape of the Fresnel-shaped portion 11a, the half mirror layer 12 serves to form a magnifying optical system. Thus, a virtual image can be formed at a position that is distant forward from the windshield WS (i.e., in the virtual image forming plane 24).

Although in the example shown in FIGS. 1 and 2 the Fresnel mirror sealed body 10 is integrated with the windshield WS, it may be disposed at a position that is distant from the windshield WS; for example, an independent combiner may be disposed over the dashboard 22 in an inclined posture.

### <Transmission Characteristic>

FIG. 3 shows the Fresnel mirror sealed body 10 in which all of the respective refractive indices n1, n2, and n3 of the materials of the Fresnel lens 11, the transparent plate 14, and the sealing agent layer 13 are identical. In this case, light refraction due to a difference in refractive index can be suppressed at the boundary between the Fresnel lens 11 and the sealing agent layer 13 and the boundary between the sealing agent layer 13 and the transparent plate 14. Where the Fresnel mirror sealed body 10 is incorporated in the windshield WS as an intermediate layer, by setting the refractive index of the material of the windshield WS and the refractive index n1 of the material of the Fresnel lens 11 identical, it is possible to have part of the windshield WS exercise the same function as the transparent plate 14 (the transparent plate 14 can be omitted).

With the above refractive index setting, optical magnification does not occur for a scene ahead of the vehicle to be seen by the driver at the eye point EP (see FIG. 2) and it is recognized as an equal-magnification image even if related incident light passes through the Fresnel mirror region FM. That is, the size, position, shape, etc. of a recognized image of a scene ahead of the vehicle do not vary between a case that the scene is viewed through the Fresnel mirror region FM and a case that it is viewed through another region of the windshield WS. As a result, even when the Fresnel mirror region FM is used, a good visual field that is necessary for driving can be secured. Furthermore, since the AR coating layers 15 and 16 suppress light reflection at the front and back surfaces of the Fresnel mirror sealed body 10, generation of an equal-magnification ghost image and halation due to internal diffuse reflection can be prevented.

Since the Fresnel mirror sealed body 10 which forms a magnifying optical system using the Fresnel lens 11 in or in the vicinity of the windshield WS, the HUD unit 20 can display a virtual image having a wide viewing angle. Furthermore, since it is not necessary for the HUD unit 20 to be equipped with a magnifying optical system, the HUD unit 20 can be miniaturized and the area of the opening 22a can be reduced.

### <Example Structure of Fresnel Lens 11>

FIGS. 4A, 4B, and 4C are a plan view, a sectional view taken along line A-A in FIG. 4A, and a sectional view taken along line B-B in FIG. 4A, respectively, showing an example structure of the Fresnel lens 11 which is included in the Fresnel mirror sealed body 10.

The Fresnel lens 11 which is a substrate body is shaped like a thin plate and made of a transparent material whose refractive index n1 is known, such as a resin or glass. The one surface of the Fresnel lens 11 is formed with the Fresnel-shaped portion 11a and the other surface is a flat surface 11c.

In the embodiment, as shown in FIG. 4A, the Fresnel lens 11 has many Fresnel grooves 31-36 whose circumferences 31a-36a have an elliptical shape or a shape similar to it. However, even where Fresnel grooves 31-36 are circular, the distortion of the optical system can also be suppressed by varying the inclination angle (sag angle) of each of the reflection surfaces 31b-36b (described later) depending on the circumferential position in the groove.

The number, the arrangement pitch, etc. of the Fresnel grooves need to be changed according to such conditions as required optical characteristics. The Fresnel grooves 31-36 are arranged concentrically around a central portion 30.

As shown in FIGS. 4B and 4C, a step is formed between adjoining ones of the Fresnel grooves 31-36. More specifically, the Fresnel-shaped portion 11a has a sawtoothed surface shape in a sectional view and the reflection surfaces 31b-36b are slant surfaces that are inclined with respect to the direction that is perpendicular to the thickness direction of the Fresnel lens 11. Although the Fresnel erection surfaces 11b extend in the thickness direction of the Fresnel lens 11 at the boundaries between the reflection surfaces 31b-36b of the Fresnel grooves 31-36, the slant reflection surfaces 31b-36b are approximately continuous with each other in a plan view so as not to form surfaces that are perpendicular to the thickness direction. Having the above-described surface shape, the Fresnel lens 11 serves as a lens in an optical sense.

The Fresnel grooves 31-36 are formed so that the light reflection characteristic of the Fresnel-shaped portion 11a is given a free surface characteristic. The inclination angle (sag angle) of each of the reflection surfaces 31b-36b of the Fresnel grooves 31-36 is set so as to vary continuously depending on the circumferential position in the groove.

Where the depth (VH, VV) of each of the Fresnel grooves 31-36 is kept constant, the distance (pitch) (PH, PV) between the circumferences defining each of the Fresnel grooves 31-36 is varied depending on the circumferential position by varying the inclination angle of the reflection surface 31b, 32b, 33b, 34b, 35b, or 36b continuously depending on the circumferential position. As a result, the circumferences 31a-36a of the Fresnel grooves 31-36 becomes elliptical.

In the example of FIGS. 4A-4C, the circumferences 31a-36a have an elliptical pattern that is wider in the X-axis direction than in the Y-axis direction and hence the distance PV between the circumferences 35a and 36a in the A-A cross section is shorter than the distance PH between the circumferences 35a and 36a in the B-B cross section. The inclination angle of the reflection surface 36b is smaller at the positions where the distance PH occurs than at the positions where the distance PV occurs. It goes without saying that the circumferences 31a-36a may have an elliptical pattern that is wider in the Y-axis direction than in the X-axis direction depending on the installation position of the Fresnel lens 11, its relationship with the position of the eye point EP, or some other factor.

Where the depth (VH, VV) of each of the Fresnel grooves 31-36 is varied according to a variation of the inclination angle (sag angle) of the reflection surface 31b, 32b, 33b, 34b, 35b, or 36b, it is possible to keep constant the distance (PH, PV) between the circumferences defining each of the Fresnel grooves 31-36. In this case, the light reflection characteristic can be given a free surface characteristic even in the case where each of the circumferences 31a-36a of the Fresnel grooves 31-36 assumes a true circle or a shape to it.

The shape of each of the circumferences 31a-36a of the Fresnel grooves 31-36 is not limited to an ellipse (see FIG. 4A) or a circle, and may be any of other shapes such as a contour line according to a necessary free surface characteristic.

For example, where the display light projecting optical system produces distortion that the vertical size and the horizontal size of a display image formed are different from each other, such distortion and a binocular parallax can be suppressed and high-quality display can thereby be attained by employing a Fresnel lens 11 having an elliptical pattern whose vertical-horizontal ratio is adjusted properly. Furthermore, since the Fresnel lens 11 is shaped like a thin plate, the Fresnel mirror sealed body 10 can be made compact.

By giving the Fresnel-shaped portion 11a of the Fresnel lens 11 a special shape as shown in FIGS. 4A-4C, the light reflection characteristic can be given a free surface characteristic and an ideal lens characteristic of an aspherical surface defined by a polynomial can be realized. As a result, even without a large lens or mirror, the imaging forming performance, the binocular parallax, the display distortion, etc. of the display light projecting optical system can be improved and its display quality can thereby be enhanced.

### <Occurrence of Equal-Magnification Double Ghost Image>

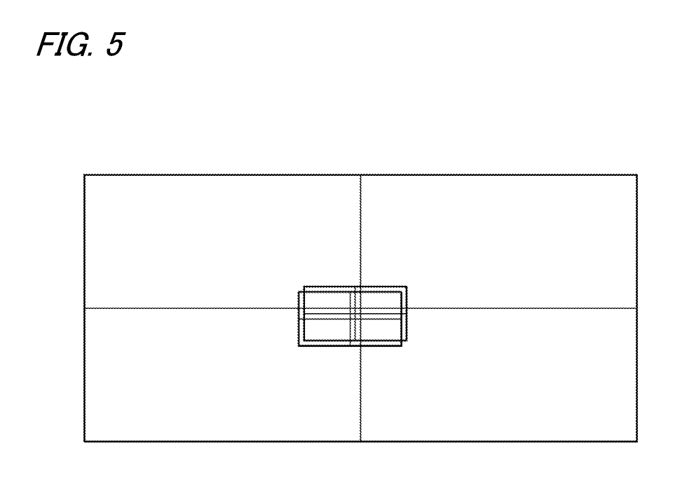

FIG. 5 shows an example image that may be seen at the eye point EP unless a proper countermeasure is taken when display light emitted from the HUD unit 20 is reflected by the Fresnel mirror sealed body 10 and then goes toward the eye point EP.

As shown in FIG. 3, display light emitted from the HUD unit 20 may reach the eye point EP after traveling along different paths. Basically, display light emitted from the HUD unit 20 passes through the transparent plate 14 and the sealing agent layer 13, is then reflected by the surface of the half mirror layer 12, and finally reaches the eye point EP in an image-enlarged state because it is given magnification when reflected by the Fresnel-shaped portion 11a having the above-described shape.

On the other hand, since the outer surface 14a of the transparent plate 14 is in contact with an air layer that is different in refractive index from the transparent plate 14, light reflection occurs at the boundary between them. As a result, part of the display light emitted from the HUD unit 20 goes toward the eye point EP after being reflected by the surface 14a of the transparent plate 14 without image enlargement. Furthermore, since the outer surface 11c of the Fresnel lens 11 is also in contact with an air layer that is different in refractive index from the Fresnel lens 11, light reflection also occurs at the boundary between them. As a result, another part of the display light emitted from the HUD unit 20 passes through the transparent plate 14, the sealing agent layer 13, the half mirror layer 12, and the Fresnel lens 11, is then reflected by the surface 11c, again passes through the Fresnel lens 11, the half mirror layer 12, the sealing agent layer 13, and the transparent plate 14, and finally reaches the eye point EP without image enlargement.

That is, as shown in FIG. 5, an image of the display light reflected by the half mirror layer 12, an image of the display light reflected by the surface 14a, and an image of the display light reflected by the surface 11c are formed at different positions after the display light beams travel along different optical paths. Furthermore, whereas the display light reflected by the half mirror layer 12 forms the image in an image-enlarged state, the reflection light coming from the surface 14a and the reflection light coming from the surface 11c form images in an equal magnification state. As a result, as shown in FIG. 5, at the eye point EP, an equal-magnification double ghost image appears like a shadow in the vicinity of the intrinsic display light image that is enlarged.

### <Method for Rendering an Equal-Magnification Double Ghost Image Fainter>

In the display light projecting optical system shown in FIG. 3, since the HUD unit 20 has a liquid crystal display panel that incorporates a polarizing plate, display light emitted from the HUD unit 20 is linearly polarized light. As shown in FIG. 3, the half-wave plate 25 is disposed between an exit portion of the HUD unit 20 and the Fresnel mirror sealed body 10. The angle formed by the half-wave plate 25 and incident light is adjusted so that display light that is output from the half-wave plate 25 is made p-polarized light.

As is well known, the half-wave (λ/2) plate 25 is a birefringent element that gives orthogonally polarized components a phase difference π (180°) and is used for changing the polarization direction of linearly polarized light. If linearly polarized light is incident on the half-wave plate 25 in such a manner that its oscillation direction forms an angle θ with the optic axis direction of the half-wave plate 25, linearly polarized light whose oscillation direction is rotated by 2θ is output from the half-wave plate 25. For example, if linearly polarized light is incident on the half-wave plate 25 in such a manner that its oscillation direction forms 45° with the optic axis direction, linearly polarized light whose oscillation direction is rotated by 90° is output from the half-wave plate 25.

When light is reflected by the boundary surface between different substances, s-polarized light and p-polarized light are defined according to the relationship between the oscillation direction of its electric field component or magnetic field component and the plane of incidence. The s-polarized light is an electromagnetic wave whose electric field component is perpendicular to the plane of incidence, and the p-polarized light is an electromagnetic wave whose electric field component is parallel with the plane of incidence.

In the display light projecting optical system shown in FIG. 3, p-polarized display light is incident on the Fresnel mirror sealed body 10 by means of the HUD unit 20 and the half-wave plate 25 and the angle of incidence of the display light on the Fresnel mirror sealed body 10 and the angle of emergence of the display light from the Fresnel mirror sealed body 10 are set approximately equal to a Brewster's angle. As a result, almost no reflection occurs at the surface 14a of the transparent plate 14 and the surface 11c of the Fresnel lens 11. The above-mentioned equal-magnification double ghost image can be prevented or made fainter.

### <Specific Example of Polarized Light Reflection Characteristic>

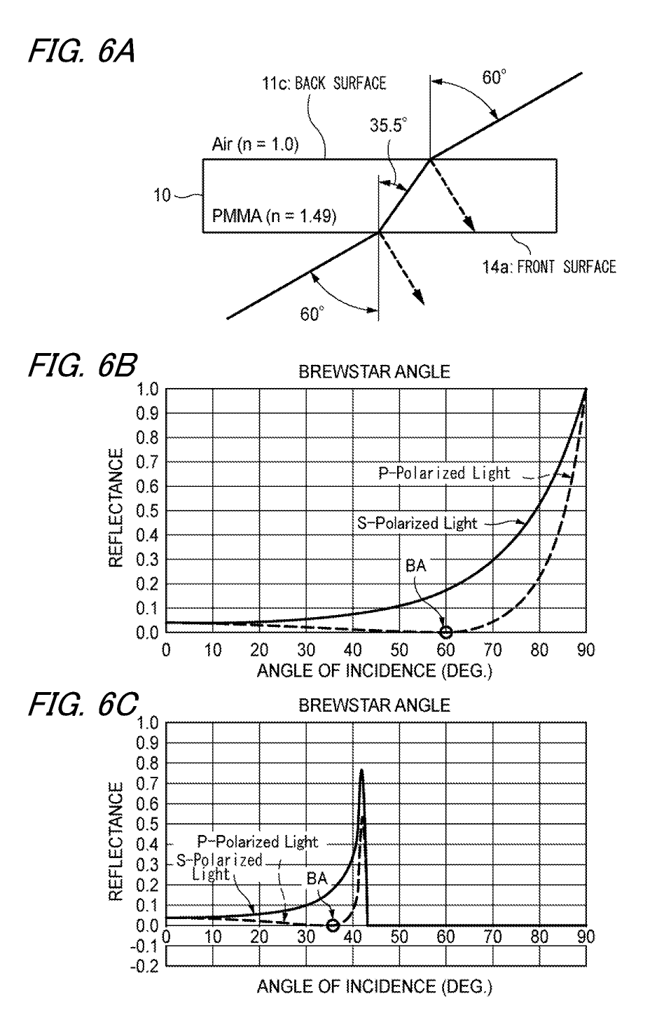

FIGS. 6A-6C show a specific example of a polarized light reflection characteristic of the Fresnel mirror sealed body 10. FIG. 6A shows an example optical path of light that passes through the Fresnel mirror sealed body 10, FIG. 6B shows a reflection characteristic at the front surface 14a of the Fresnel mirror sealed body 10, and FIG. 6C shows a reflection characteristic at the back surface 11c of the Fresnel mirror sealed body 10. In the graphs of FIGS. 6B and 6C, the horizontal axis represents the angle of incidence and the vertical axis represents the reflectance.

The example of FIGS. 6A-6C assumes that the transparent material of the Fresnel mirror sealed body 10 is a PMMA (polymethyl methacrylate) resin and the Fresnel mirror sealed body 10 is surrounded by an air layer. The refractive indices n of PMMA and air are 1.49 and 1, respectively.

The Brewster's angle is an incident angle at which the reflectance of p-polarized light that is incident on the interface between substances having different refractive indices becomes equal to 0. For example, in the graph of FIG. 6B, the reflectance of p-polarized light becomes equal to 0 when its incident angle is equal to about 60° and hence the Brewster's angle BA is 60°. In the graph of FIG. 6C, the reflectance of p-polarized light becomes equal to 0 when its incident angle is equal to about 35.5° and hence the Brewster's angle BA is 35.5°.

If as shown in FIG. 6A p-polarized light is incident on the surface 14a of the Fresnel mirror sealed body 10 from outside at an incident angle 60°, the reflectance at the surface 14a becomes equal to 0. Furthermore, if p-polarized light is incident on the surface 11c of the Fresnel mirror sealed body 10 at an incident angle 35.5° after passing through the inside of the Fresnel mirror sealed body 10, the reflectance at the surface 11c becomes equal to 0.

As seen from FIGS. 6B and 6C, there exists a tendency that the reflectance of p-polarized light is smaller than that of s-polarized light at any incident angle. Thus, where p-polarized display light is incident on the Fresnel mirror sealed body 10 by means of the HUD unit 20 and the half-wave plate 25 as in the display light projecting optical system shown in FIG. 3, the degree of reflection at the surfaces 14a and 11c can be made lower than in the case where s-polarized display light is. By setting the angle of incidence of p-polarized light on the surface 14a and the angle of incidence of p-polarized light on the surface 11c close to the Brewster's angles, almost no unnecessary reflection occurs at each of the surfaces 14a and 11c, whereby occurrence of the above-mentioned equal-magnification double ghost image can be prevented.

### <Modification>

In the display light projecting optical system shown in FIG. 3, the half-wave plate 25 is used to produce p-polarized display light because the HUD unit 20 incorporates the flat panel display which includes the polarizing plate. Where the HUD unit 20 does not include a polarizing plate, a special polarizing plate is used to extract only p-polarized light which facilitates reduction of unnecessary reflection from unpolarized display light that includes various polarization components. For example, it is possible to have p-polarized display light be incident on the Fresnel mirror sealed body 10 by disposing a polarizing plate in place of the half-wave plate 25 shown in FIG. 3.

Features of the above-described display light projecting optical system according to the embodiment of the invention will be summarized concisely below in the form of items [1] to [5]:

[1] A display light projecting optical system comprising:
a display unit (HUD unit 20) which emits display light; and
a Fresnel mirror (Fresnel mirror sealed body 10) which reflects the display light coming from the display unit with image enlargement and transmits external light, the Fresnel mirror comprising:
   a first member (Fresnel lens 11) having a Fresnel-shaped surface (Fresnel-shaped portion 11a) formed with Fresnel-shaped plural grooves and a first surface (flat surface 11c) on which the external light is incident;
   a half mirror layer (12) which is formed on the Fresnel-shaped surface; and
   a second member (sealing agent layer 13) which has a second surface (13a or 14a) on which the display light coming from the display unit is incident, and which seals the half mirror layer between itself and the first member,
wherein p-polarized display light is incident on the second surface.

[2] The display light projecting optical system according to the above item [1], wherein the display unit emits the p-polarized display light so that it is incident on the second surface at an incident angle that is close to a Brewster's angle.

[3] The display light projecting optical system according to above item [1] or [2], wherein the display unit comprises:
a light source (HUD unit 20) which emits display light; and
a polarizing member (half-wave plate 25) which polarizes the display light emitted from the light source into p-polarized light for the second surface.

[4] The display light projecting optical system according to the above item [3], wherein:
the light source emits linearly polarized display light; and
the polarizing member is a half-wave plate (25) which polarizes the linearly polarized display light into p-polarized light for the second surface.

[5] The display light projecting optical system according to the above item [3], wherein:
the light source emits unpolarized display light; and
the polarizing member is a polarizing plate which polarizes the unpolarized display light into p-polarized light for the second surface.

What is claimed is:

1. A display light projecting optical system comprising:
a display unit which emits display light; and
a Fresnel mirror which reflects the display light coming from the display unit with image enlargement and transmits external light, the Fresnel mirror comprising:
a first member having a Fresnel-shaped surface formed with Fresnel-shaped plural grooves and a first surface on which the external light is incident;
a half mirror layer which is formed on the Fresnel-shaped surface; and
a second member which has a second surface on which the display light coming from the display unit is incident, and which seals the half mirror layer between itself and the first member,
wherein p-polarized display light is incident on the second surface.

2. The display light projecting optical system according to claim 1, wherein the display unit emits the p-polarized display light so that it is incident on the second surface at an incident angle that is close to a Brewster's angle.

3. The display light projecting optical system according to claim 1, wherein the display unit comprises:
a light source which emits display light; and
a polarizing member which polarizes the display light emitted from the light source into p-polarized light for the second surface.

4. The display light projecting optical system according to claim 3, wherein:
the light source emits linearly polarized display light; and
the polarizing member is a half-wave plate which polarizes the linearly polarized display light into p-polarized light for the second surface.

5. The display light projecting optical system according to claim 3, wherein:
the light source emits unpolarized display light; and
the polarizing member is a polarizing plate which polarizes the unpolarized display light into p-polarized light for the second surface.
